(19) United States
(12) Patent Application Publication
(10) Pub. No.: US 2006/0209987 A1
(43) Pub. Date: Sep. 21, 2006

(54) Receiver and its adjustment system and method

(76) Inventors: Hiroshi Miyagi, Niigata (JP); Hiroshi Katsunaga, Kariya-shi (JP)

Correspondence Address: DELLETT & WALTERS, P. O. BOX 82788, PORTLAND, OR, 97282-0788, US

(21) Appl. No.: 10/525,603

(22) PCT Filed: Jul. 30, 2003
(86) PCT No.: PCT/JP03/09642

§ 371 Date: Nov. 10, 2005

(30) Foreign Application Priority Data
Aug. 30, 2002 (JP) 2002-253166

(51) Int. Cl. H04L 27/00

(52) U.S. Cl. 375/316

(57) ABSTRACT

A receiver and its adjustment system and method that can reduce the effort and the cost required to give good characteristics. The receiver comprises a quadrature detector whose characteristics value is varied by adjusting the capacitance. The quadrature detector comprises a variable capacitance circuit 182 formed on a semiconductor substrate and an LC parallel resonance circuit 20 comprising an inductor 120 and a capacitor 122 formed outside the semiconductor substrate. The characteristic value of the quadrature detector is adjusted by varying the capacitance of the variable capacitance circuit 182.

### TECHNICAL FIELD

The present invention relates to a receiver for performing fine adjustment of a quadrature detector and so on and its adjustment system and method.

### BACKGROUND ART

Conventionally, various detection methods are used for an FM receiver, such as a Foster-Seeley detector, a ratio detector and a quadrature detector. Of these detectors, the quadrature detector eliminates a predetermined high-frequency component from a result of multiplying an intermediate frequency signal of a predetermined frequency by a signal having shifted a phase of this signal by π/2 so as to perform FM detection. It requires a π/2 phase shifter for shifting a phase of an inputted intermediate frequency signal just by π/2. The π/2 phase shifter is configured by, for instance, combining inductors and coils in parallel or in series.

As there are variations on manufacturing as to the inductors and capacitors included in the above-mentioned π/2 phase shifter, their element constants are also uneven in a certain range. For instance, inductance of the inductors and capacitance of the capacitors are uneven in the range of ±10 percent. As a matter of course, in the case where the π/2 phase shifter is configured by combining these inductors and capacitors, a frequency of which phase shift amount is π/2 gets deviated from the predetermined frequency so that the quadrature detector, that is, the FM receiver using the quadrature detector cannot obtain good characteristics. For this reason, it conventionally takes the effort and cost to obtain the good characteristics since parts having desired characteristics are selected and used out of significantly variable parts and expensive parts such as ceramic filters are used to stabilize the frequency.

### DISCLOSURE OF THE INVENTION

The present invention has been made in view of such points, and an object thereof is to provide a receiver capable of reducing such effort and cost to obtain the good characteristics and its adjustment system and method.

To solve the above-mentioned problems, the receiver of the present invention comprises a detector of which characteristic values are varied by adjusting a capacitance value. This detector comprises a variable capacitance circuit formed on a semiconductor substrate and a resonance circuit composed of an inductor and a first capacitor formed outside the semiconductor substrate, where the characteristic values of the detector are adjustable by varying the capacitance value of the variable capacitance circuit. Thus, it is possible, even in the case where there are variations on manufacturing as to element constants of the inductor and capacitor of the resonance circuit comprising the detector, to vary the capacitance value of the variable capacitance circuit formed on the semiconductor substrate and thereby adjust the characteristic values of the detector. Therefore, it is unnecessary, for the sake of obtaining good characteristics as the detector or the receiver, to select less variable parts or use expensive parts so as to reduce the effort and cost.

The above-mentioned variable capacitance circuit should desirably comprise a plurality of second capacitors and switches for having each of the second capacitors combined and connected in parallel. Thus, it is possible, by connecting the second capacitors in parallel while varying their combinations, to obtain large capacitance by using a small number of the second capacitors.

The plurality of second capacitors should desirably have mutually different capacitance values, respectively. It is thereby possible to obtain still larger capacitance by varying the combinations of the second capacitors.

It is also desirable that each of the above-mentioned plurality of second capacitors be set at twice the capacitance in geometric progression. It is thereby possible, by combining the second capacitors, to obtain the capacitance values increasing and decreasing at predetermined intervals.

It is also desirable that the above-mentioned variable capacitance circuit further comprise a storage unit for storing data of the number of bits at least more than the number of switches and have a connection state of the switches set according to the values of the bits of the data stored in the storage unit. It is thereby possible to set the connection state of each switch just by storing predetermined data in the storage unit so as to reduce the effort on adjusting the characteristics of the detector.

It is also desirable that the FM receiver further comprise a nonvolatile memory holding the data corresponding to characteristic values of the detector for optimizing a receiving state measured in advance and a control unit for reading the data held in the memory and storing it in the storage unit before starting a receiving operation. It is thereby possible to perform adjustment work for each receiver just by acquiring in advance and storing the data for optimizing the receiving state in the memory so as to reduce the effort on adjusting the receiver to an optimal receiving state.

It is also desirable that the above-mentioned control unit detects temperature of the detector and varies the contents of the data stored in the storage unit according to a variance of the temperature before starting the receiving operation. It is thereby possible to keep the optimal receiving state of the receiver even in the case where the temperature fluctuates and the characteristics of the detector vary.

It is also desirable that the above-mentioned control unit detects a power supply voltage and varies the contents of the data stored in the storage unit before starting the receiving operation according to a variance of the power supply voltage. It is thereby possible to keep the optimal receiving state of the receiver even in the case where the power supply voltage fluctuates and the characteristics of the detector vary.

It is also desirable that the above-mentioned detector be a quadrature detector having a π/2 phase shifter comprised of the resonance circuit and variable capacitance circuit, where the capacitance value of the variable capacitance circuit is variable and a phase shift amount of the π/2 phase shifter against an input signal is thereby accurately adjustable to π/2. Even in the case where the element constants of the resonance circuit and other elements are not fixed due to the variations on manufacturing, it is possible, by rendering the capacitance value of the variable capacitance circuit variable, to set the phase shift amount of the π/2 phase shifter accurately to π/2 against the input signal. Therefore, it is possible to use various parts of which element constants are uneven as-is on manufacturing so that there is no need to use expensive parts. Thus, it is possible to significantly reduce cost of parts.

It is also desirable that the above-mentioned semiconductor substrate has other component circuits formed thereon integrally with the variable capacitance circuit. It is thereby possible to reduce the cost by decreasing the number of parts.

It is also desirable that the circuits on the above-mentioned substrate are formed by using a CMOS process or a MOS process. It is thereby possible to simplify a manufacturing process and miniaturize the parts.

The adjustment system of the receiver of the present invention adjusts the above-mentioned receiver to an optimal receiving state, and comprises a signal generator for inputting a test signal to the receiver, a measuring instrument for measuring the receiving state of the receiver, and an adjusting apparatus for determining the receiving state of the receiver based on a measurement result by the measuring instrument and switching the connection state of the plurality of second capacitors included in the variable capacitance circuit so as to optimize the receiving state. An adjustment method of the receiver of the present invention is the method of optimizing the receiving state of the above-mentioned receiver, and comprises steps of inputting the test signal to the receiver, measuring the receiving state of the receiver, and determining the receiving state of the receiver based on the measurement result of the receiving state of the receiver and switching the connection state of the plurality of second capacitors included in the variable capacitance circuit so as to optimize the receiving state. It is possible, by using this adjustment system or performing this adjustment method, to set an optimal receiving state of the receiver while switching the connection state of the plurality of second capacitors in the variable capacitance circuit even in the case of using the parts of which element constants on manufacturing are significantly variable. Thus, it is possible to reduce the effort required for selection of the parts and also reduce the cost of parts.

The adjustment system of the receiver of the present invention adjusts the receiver having the above-mentioned memory to the optimal receiving state, and comprises a signal generator for inputting a test signal to the receiver, a measuring instrument for measuring the receiving state of the receiver, and a controlling apparatus for determining the receiving state of the receiver based on the measurement result of the measuring instrument and determining the data to be stored in the storage unit and writing the data to the memory so as to optimize the receiving state.

The adjustment method of the receiver of the present invention is the method of adjusting the receiver having the above-mentioned memory to the optimal receiving state, and comprises the steps of inputting a test signal to the receiver, measuring the receiving state of the receiver, and determining the receiving state of the receiver based on the measurement result of the receiving state of the receiver, determining the data to be stored in the storage unit and writing the data to the memory so as to optimize the receiving state.

Even in the case of using the parts of which element constants on manufacturing are significantly variable, it is possible, by using this adjustment system or performing this adjustment method, to keep the optimal receiving state of the receiver on normal operation just by setting the optimal receiving state of the receiver while switching the connection state of the plurality of second capacitors in the variable capacitance circuit and storing the data of this time in the memory so as to reduce the effort required for selection of the parts and also reduce the cost of parts.

### BRIEF DESCRIPTION OF THE DRAWINGS

FIG. 1 is a diagram showing a configuration of an FM receiver according to an embodiment;

FIG. 2 is a diagram showing a detailed configuration of a quadrature detector comprised of an FM detector circuit and an LC parallel resonance circuit;

FIG. 3 is a diagram showing a detailed configuration of a variable capacitance circuit;

FIG. 4 is a diagram showing an overall configuration of an adjustment system including the FM receiver;

FIG. 5 is a diagram showing a relation between an output Vo of a level meter and data N to be stored in a register in the variable capacitance circuit;

FIG. 6 is a flowchart showing an operating procedure for measuring an optimal value with a personal computer;

FIG. 7 is a flowchart showing the operating procedure for starting the FM receiver after finishing an adjustment shown in FIG. 6;

FIG. 8 is a flowchart showing the operating procedure of the FM receiver in consideration of temperature variation; and

FIG. 9 is a flowchart showing the operating procedure of the FM receiver in consideration of fluctuation of power supply voltage.

### BEST MODE FOR CARRYING OUT THE INVENTION

Hereunder, an FM receiver according to an embodiment of the present invention will be described in detail by referring to the drawings.

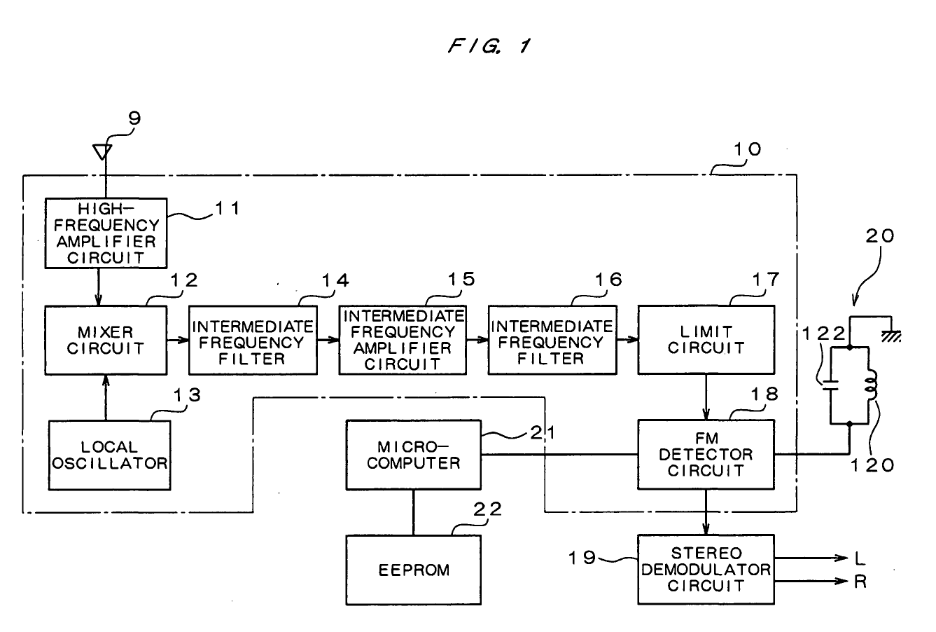

FIG. 1 is a diagram showing a configuration of the FM receiver according to this embodiment. The FM receiver shown in FIG. 1 comprises a high-frequency amplifier circuit 11, a mixer circuit 12, a local oscillator 13, intermediate frequency filters 14, 16, an intermediate frequency amplifier circuit 15, a limit circuit 17, an FM detector circuit 18 which are formed as a one-chip part 10, and a stereo demodulator circuit 19, an LC parallel resonance circuit 20, a microcomputer 21 and an EEPROM 22 provided separately from the one-chip part 10.

An FM modulated wave received by an antenna 9 is amplified by the high-frequency amplifier circuit 11, and then a local oscillation signal outputted from the local oscillator 13 is mixed therewith so as to perform conversion from a high-frequency signal to an intermediate frequency signal. The intermediate frequency filters 14, 16 are provided in a preceding stage and a subsequent stage to the intermediate frequency amplifier circuit 15, and extract only predetermined band components from the intermediate frequency signals that are inputted. The intermediate frequency amplifier circuit 15 amplifies some of the intermediate frequency signals passing through the intermediate frequency filters 14, 16. The limit circuit 17 amplifies the inputted intermediate frequency signals at a high gain, and outputs signals of fixed amplitude. The FM detector circuit 18 forms a quadrature detector together with the LC parallel resonance circuit 20 connected to the outside of the one-chip part 10, and performs an FM detection process to the signals of a fixed amplitude outputted from the limit circuit 17. The above-mentioned one-chip part 10 is integrally formed on a semiconductor substrate by using the CMOS process or the MOS process. As for this semiconductor substrate, there may be the cases where various analog and digital circuits are formed thereon apart from the cases where only the circuits configuring the one-chip part 10 shown in FIG. 1 are formed thereon. The stereo demodulator circuit 19 performs a stereo demodulation process to FM-detected composite signals outputted from the FM detector circuit 18 so as to generate L signals and R signals.

As for the quadrature detector according to this embodiment comprised of the FM detector circuit 18 and LC parallel resonance circuit 20, it is necessary to generate a signal of which phase is shifted exactly by π/2 from the intermediate frequency signal of a predetermined frequency (10.7 MHz for instance) inputted from the limit circuit 17. The LC parallel resonance circuit 20 is used for this reason. However, variations on manufacturing are allowed to an extent as to element constants of an inductor 120 and a capacitor 122 configuring the LC parallel resonance circuit 20 and the element constant of the capacitor included in the FM detector circuit 18. Therefore, it is almost difficult to shift the phase of an input signal exactly by 90 degrees with no adjustment on combining these parts. For this reason, according to this embodiment, a variable capacitance circuit (described later) of which capacitance value is variable is included in the FM detector circuit 18. And it is possible, by adjusting the capacitance value of this circuit, to shift the phase of the input signal exactly by π/2.

The microcomputer 21 is a control unit for, on starting up the FM receiver, setting the capacitance value of the variable capacitance circuit included in the FM detector circuit 18 to a predetermined adjusted value. As for this adjusted value, a value measured in advance on manufacturing the FM receiver is used. The EEPROM 22 is a nonvolatile memory for storing this adjusted value.

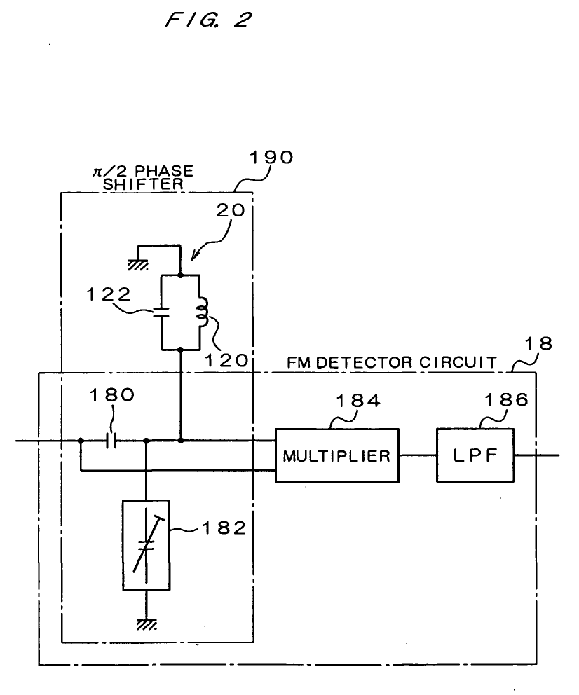

Next, the quadrature detector of this embodiment will be described in detail. FIG. 2 is a diagram showing a detailed configuration of the quadrature detector comprised of the FM detector circuit 18 and the LC parallel resonance circuit 20.

As shown in FIG. 2, the FM detector circuit 18 comprises a capacitor 180, a variable capacitance circuit 182, a multiplier 184 and an LPF (low-pass filter) 186. A π/2 phase shifter 190 is comprised of the capacitor 180 and variable capacitance circuit 182 and also the LC parallel resonance circuit 20 connected to the outside. The variable capacitance circuit 182 is connected to the LC parallel resonance circuit 20 in parallel, and the capacitor 180 is further connected in series to these parallel circuits. The capacitance value of the variable capacitance circuit 182 is arbitrarily settable in a predetermined range. And the capacitance value is adjusted to set a phase shift amount of the π/2 phase shifter 190 to exactly π/2 against the intermediate frequency signal of the predetermined frequency.

The multiplier 184 multiplies the intermediate frequency signal outputted from the limit circuit 17 by the signal having the phase of the intermediate frequency signal shifted by π/2 with the π/2 phase shifter 190. The LPF 186 eliminates unnecessary high-frequency components included in an output signal of the multiplier 184.

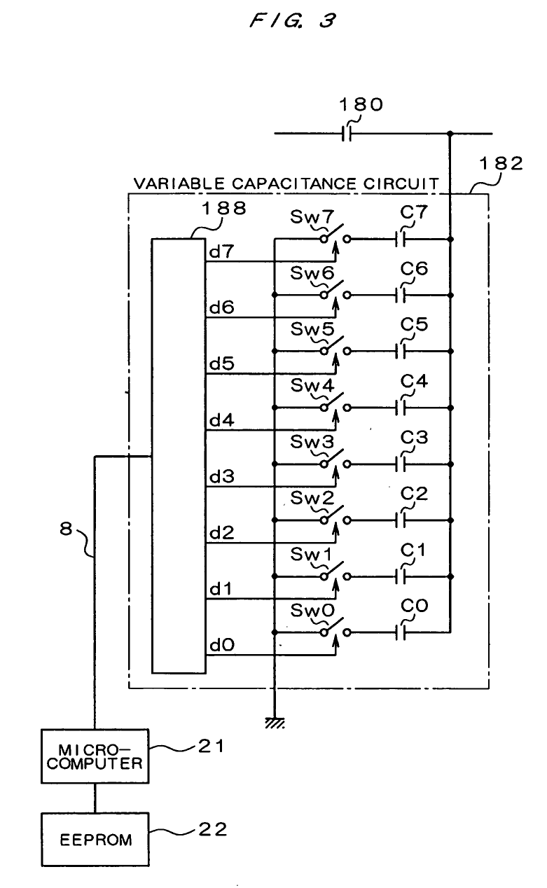

FIG. 3 is a diagram showing a detailed configuration of the variable capacitance circuit 182. As shown in FIG. 3, the variable capacitance circuit 182 comprises a register 188, switches Sw0 to Sw7 and capacitors C0 to C7. The register 188 is the storage unit for storing 8-bit data, and outputs the bits from its lowest order d0 to its highest order bit d7 in parallel.

The capacitor C0 has its one end connected to one end of the LC parallel resonance circuit 20 and its other end grounded via the switch Sw0. As the other end of the LC parallel resonance circuit 20 is grounded so that, on turning the switch Sw0 on, the capacitor C0 is further connected to the LC parallel resonance circuit 20 in parallel. Likewise, each of the capacitors C1 to C7 has its one end connected to one end of the LC parallel resonance circuit 20 and its other end grounded via one of the switches Sw1 to Sw7. If each of the switches Sw1 to Sw7 is turned on, one of the capacitors C1 to C7 corresponding thereto is connected to the LC parallel resonance circuit 20 in parallel.

Each of the switches Sw0 to Sw7 has its on and off state set correspondingly to the values of the bits d0 to d7 of the 8-bit data stored in the register 188. To be more precise, the switch Sw0 is corresponding to the lowest order bit do so that it is turned on when the value of do is “1” and turned off when “0.” Likewise, each of the switches Sw1 to Sw7 is corresponding to each of the first bit d1 to the highest order bit d7 so that it is turned on when the value of each bit is “1” and turned off when “0.”

When the capacitance of the capacitor C0 is Ct (=2⁰×Ct), the capacitance of the capacitor C1 is set as 2Ct (=2¹×Ct), that of the capacitor C2 as 4Ct (=2²×Ct) . . . , and that of the capacitor C7 as 128 Ct (=2⁷×Ct) respectively.

The above-mentioned variable capacitance circuit 182 has the lowest capacitance Cmin (=Ct) when only the switch Sw0 connected in series to the capacitor C0 is turned on, and has the highest capacitance Cmax (=(2⁰+2¹+2²+2³+2⁴+2⁵+2⁶+2⁷)Ct) when the switches Sw0 to Sw7 connected to all the capacitors C0 to C7 respectively are turned on. It is possible to vary the contents of the data stored in the register 188 and appropriately turn on and off the switches Sw0 to Sw7 so as to switch the capacitance value of the entire variable capacitance circuit 182 stepwise in units of Ct in the range of Cmin to Cmax.

Thus, even in the case where there are variations in the element constants of the inductor 120 and capacitor 122 configuring the LC parallel resonance circuit 20 and the element constants of the capacitor 180 included in the FM detector circuit 18 so that the phase shift amount of the π/2 phase shifter 190 configured by combining the LC parallel resonance circuit 20, capacitor 180 and so on is not exactly π/2 against the intermediate frequency signal of 10.7 MHz for instance, it is possible to securely set it to π/2 by setting the capacitance value of the variable capacitance circuit 182 at an adequate value.

It is empirically known that there are variations in the range of ±5 percent as to the element constants of the inductor 120 and capacitor 122 configuring the LC parallel resonance circuit 20. To be more specific, there are variations in the range of ±10 percent as to the entire LC parallel resonance circuit 20. Therefore, it is sufficient if a resonance frequency is variable in the range of ±10 percent (2140 kHz) in proximity to the intermediate frequency signal of 10.7 MHz. It is also known that it is sufficient if the resonance frequency is variable in units of 10 kHz in the above frequency range, where the number of necessary steps M is 214 (=2140/10). If the data to be stored in the above-mentioned register 188 is 8 bits, a practical adjustment becomes possible by securing 256(=2⁸) as the number of steps.

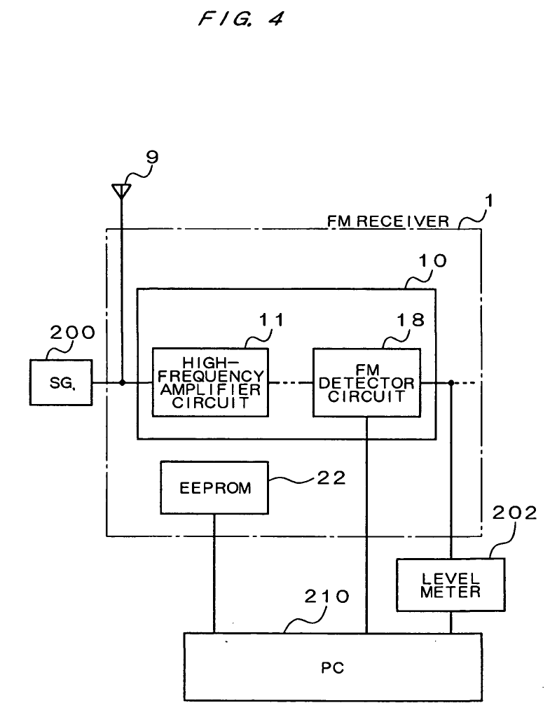

Next, a concrete adjustment method of the FM receiver of this embodiment will be described. FIG. 4 is a diagram showing an overall configuration of the adjustment system including the FM receiver. This adjustment system comprises a signal generator (SG) 200, a level meter 202 and a PC (personal computer) 210 in addition to an FM receiver 1 of this embodiment.

The signal generator 200 generates a test signal of a predetermined frequency. For instance, the test signal of a frequency included in a receiving band of an FM broadcast is outputted from the signal generator 200 to be inputted to the high-frequency amplifier circuit 11. The level meter 202 is a measuring instrument for measuring the level of the signal outputted from the FM detector circuit 18 included in the FM receiver. According to this embodiment, an output signal of the FM detector circuit 18 is inputted to the level meter 202. However, it is also possible to input the output signal of the stereo demodulator circuit 19 to the level meter 202.

The PC 210 operates as a controlling apparatus which executes a predetermined program for adjustment stored in a memory and a hard disk drive and thereby adjusts the capacitance value of the variable capacitance circuit 182 in the FM detector circuit 18 while monitoring the output of the level meter 202 so as to write the result thereof to the EEPROM 22.

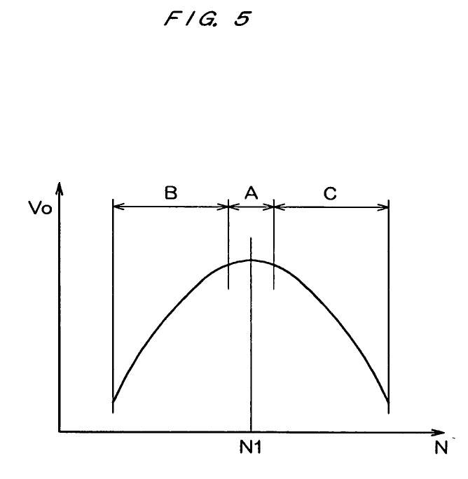

FIG. 5 is a diagram showing a relation between an output Vo of the level meter 202 and data N to be stored in the register 188 in the variable capacitance circuit 182. As for the data N to be stored in the register 188, there exists an optimal value N1 at which the output Vo of the level meter 202 becomes maximum when the phase shift amount of the π/2 phase shifter 190 including the variable capacitance circuit 182 is π/2. The optimal value N1 is different as to each FM receiver according to variations on manufacturing the inductor 120 and capacitor 122, and soon, configuring the LC parallel resonance circuit 20. The PC 210 measures the optimal value N1 as to each FM receiver.

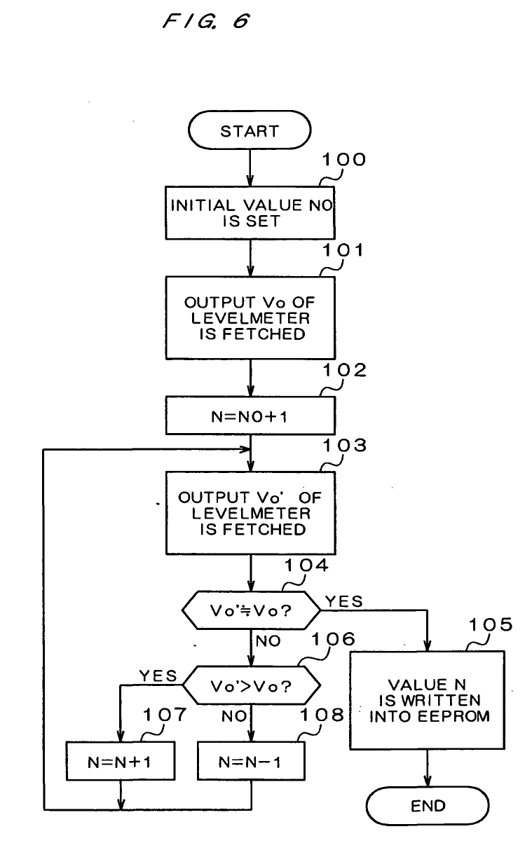

FIG. 6 is a flowchart showing an operating procedure for measuring the optimal value N1 with the PC 210. First, the PC 210 sets an initial value N0 as the data N to be stored in the register 188 (step 100). For instance, an average value of a plurality of the optimal values N1 corresponding to a plurality of the FM receivers 1 obtained by the measurements so far is used as the initial value N0. After the initial value N0 is stored in the register 188, the PC 210 fetches the output Vo of the level meter 202 (step 101).

After updating the data N (=N0) to be stored in the register 188 by adding 1 thereto (step 102), the PC 210 fetches an output Vo′ of the level meter 202 (step 103).

Next, the PC 210 determines whether or not the output Vo′ of the level meter 202 fetched for the second time approximately matches with the output Vo of the level meter 202 fetched for the first time (step 104). As shown in FIG. 5, the output Vo of the level meter 202 varies little once the data N to be stored in the register 188 is included in a range A in proximity to the optimal value N1. In the step 104, it is determined whether or not the data N is included in the range A. In the case where the outputs Vo and Vo′ of the level meter 202 fetched twice are approximately equal (including both the cases where they match completely and where they do not match completely but their difference is within a predetermined value), an affirmative judgment is made in determination in the step 104. Next, the PC 210 writes the data N to the EEPROM 22 (step 105), and finishes a series of adjustment operations.

In the case where the outputs Vo and Vo′ of the level meter 202 fetched twice do not match, a negative judgment is made indetermination in the step 104, and the PC 210 determines next whether or not the output Vo′ of the level meter 202 fetched later is larger than the output Vo fetched earlier (step 106). The case where the output Vo′ fetched later is larger than the output Vo fetched earlier is the case where the data N at the time is included in a range B shown in FIG. 5. In this case, an affirmative judgment is made in the step 106. Next, the PC 210 updates the value of the data N by adding 1 (step 107), and then returns to the step 103 so as to repeat a fetch operation of the output Vo′ of the level meter 202. Inversely, in the case where the output Vo′ fetched later is smaller than the output Vo fetched earlier and the data N at the time is included in a range C shown in FIG. 5, a negative judgment is made in determination in the step 106. Next, the PC 210 updates the value of the data N by subtracting 1 (step 108), and then returns to the step 103 so as to repeat the fetch operation of the output Vo′ of the level meter 202.

Thus, according to the FM receiver 1 of this embodiment, it is possible to vary the capacitance value of the variable capacitance circuit 182 by rendering the data N to be stored in the register 188 variable so as to accurately adjust the frequency at which the phase shift amount is π/2 on the π/2 phase shifter 190 configured by the variable capacitance circuit 182, capacitor 180 and LC parallel resonance circuit 20. In particular, it is possible to set the capacitance values of the plurality of capacitors C0 to C7 included in the variable capacitance circuit 182 to be twice in sequence and use them by connecting them in parallel in adequate combinations so as to vary the capacitance values at fixed intervals by combining a small number of capacitors.

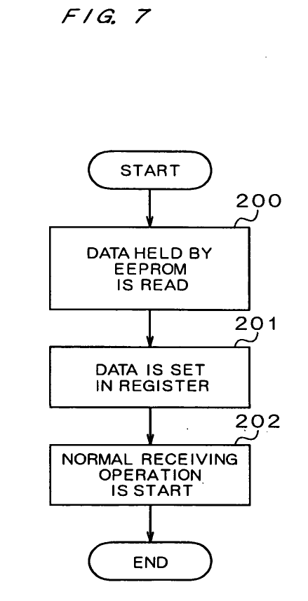

FIG. 7 is a flowchart showing the operating procedure for starting the FM receiver 1 after finishing the adjustment shown in FIG. 6.

On having a power switch (not shown) of the FM receiver 1 turned on, the microcomputer 21 reads the data N stored in the EEPROM 22 (step 200), and sets it in the register 188 in the variable capacitance circuit 182 (step 201). As the data N has the optimal value N1 set up therein, which is measured in advance to operate the FM detector circuit 18 in an optimal state, it is possible to set the data N in the register 188 so as to set an optimal receiving state each time the power switch of the FM receiver 1 is turned on. Thus, the FM receiver 1 starts normal receiving operation after the data N is completely set (step 202).

Thus, according to the receiver of this embodiment, even in the case where there are variations in the element constants of the inductor 120 and capacitor 122 included in the LC parallel resonance circuit 20 configuring the quadrature detector, it is possible to vary the capacitance value of the variable capacitance circuit 182 formed on the semiconductor substrate and thereby adjust characteristic values of the detector. Therefore, it is not necessary to select less variable parts or use expensive parts in order to obtain good characteristics as the detector or receiver, and so the effort and cost can be alleviated.

As for the variable capacitance circuit 182, it is possible to connect the capacitors C0 to C7 in parallel while varying their combinations so as to obtain large capacitance by using a small number of the capacitors. It is also possible to have different capacitance values for these capacitors so as to obtain still larger capacitance by varying the combinations of the capacitors connected in parallel. In particular, it is possible, by setting the capacitance values of the capacitors to have twice the capacitance mutually and varying the combinations of the capacitors, to obtain the capacitance values increasing and decreasing at predetermined intervals.

The variable capacitance circuit 182 comprises the register 188 for storing the data of the number of bits corresponding to the number of the switches Sw0 to Sw7. It is possible to set the connection state of each switch just by storing the data in the register 188 so as to alleviate the effort on adjusting the characteristics of the detector.

The receiver also comprises the EEPROM 22 for, on having the characteristic values of the detector for implementing the optimal receiving state measured in advance, holding the data corresponding to the characteristic values, and the microcomputer 21 for reading the data held by the EEPROM 22 and storing it in the register 188 before starting the receiving operation. Therefore, it is possible to perform adjustment work for each receiver just by acquiring in advance the data for optimizing the receiving state and storing it in the EEPROM 22 so as to alleviate the effort on adjusting the receiver to the optimal receiving state.

As the semiconductor substrate has other component circuits integrally formed with the variable capacitance circuit 182 thereon, it is possible to reduce the cost by decreasing the number of parts. In particular, it is possible to form the circuits on the semiconductor substrate by using the CMOS process or MOS process so as to simplify the manufacturing process and miniaturize the parts.

The present invention is not limited to the above embodiment, and various modifications thereof are possible within the gist of the present invention. According to the above embodiment, the data N for implementing the optimal receiving state of the FM receiver is measured in advance and stored in the EEPROM 22 to read the data N on turning on the power switch. In the case where temperature variation is intense or in the case of using an element of which characteristic values vary significantly according to the temperature variation, however, it is desirable to reset the data N not only on turning on the power switch but also on significant temperature variation.

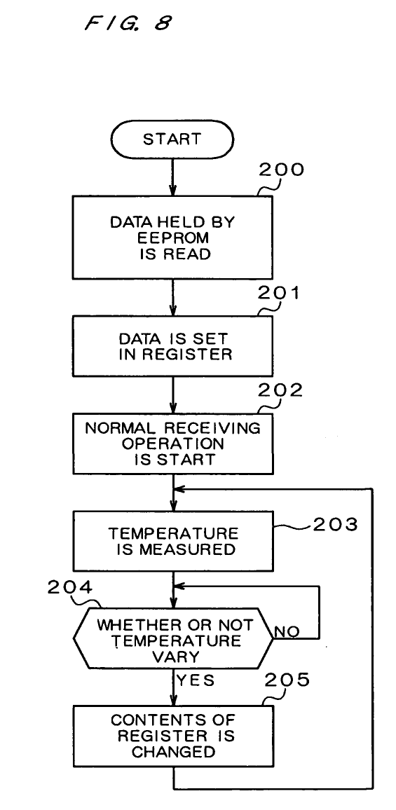

FIG. 8 is a flowchart showing the operating procedure of the FM receiver in consideration of the temperature variation. As with the FM receiver not considering the temperature variation, on turning on the power switch (not shown), the microcomputer 21 first reads the data N held by the EEPROM 22 (step 200), and sets it in the register 188 in the variable capacitance circuit 182 (step 201). Thereafter, the FM receiver starts the normal receiving operation (step 202).

Next, the microcomputer 21 measures ambient temperature of the LC parallel resonance circuit 20 and the FM detector circuit 18 (step 203). This measurement is performed by using an element of which current value and both end voltage are dependent on the temperature. For instance, the above-mentioned ambient temperature can be easily measured by passing a current through a diode and checking that value.

Next, the microcomputer 21 determines whether or not there has been predetermined temperature variation (step 204). It is determined whether or not there has been the temperature variation exceeding a predetermined range (±10 degrees or more, for instance) in reference to the temperature at the time of setting the data N in the register 188. In the case where there has been little temperature variation or temperature variation with little variance, a negative judgment is made in the determination in the step 204 and this determination operation is repeated.

In the case where there has been temperature variation exceeding the predetermined range, an affirmative judgment is made in the determination in the step 204, and then the microcomputer 21 varies the contents of the data N stored in the register 188 to a value corresponding to the temperature after the variation (step 205). It is possible to measure in advance or acquire the extent to which the data N stored in the register 188 should be varied according to the extent of the temperature variation by calculating it based on temperature coefficients such as the inductance of the inductor 120 and the capacitance of capacitor 122. Once the value of the data N stored in the register 188 is varied, it returns to the step 203 so as to repeat the process from temperature measurement onward.

Thus, even in the case where the temperature varies and the characteristics of the quadrature detector thereby vary, it is possible to adjust the capacitance value of the variable capacitance circuit 182 according to the varying temperature so as to constantly implement the optimal receiving state.

It is also feasible to monitor fluctuation of the power supply voltage after the FM receiver starts the receiving operation and appropriately vary the value of the data N to be stored in the register 188.

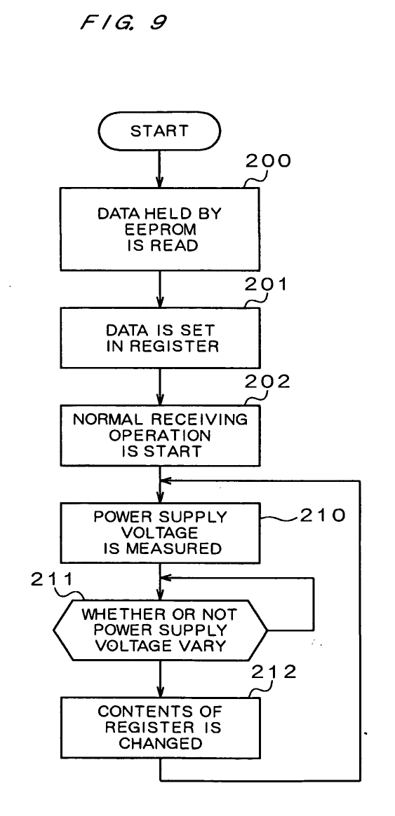

FIG. 9 is a flowchart showing the operating procedure of the FM receiver in consideration of the fluctuation of the power supply voltage. As with the FM receiver not considering the temperature variation, on turning on the power switch (not shown), the microcomputer 21 first reads the data N held by the EEPROM 22 (step 200), and sets it in the register 188 in the variable capacitance circuit 182 (step 201). Thereafter, the FM receiver starts the normal receiving operation (step 202).

Next, the microcomputer 21 measures the power supply voltage (step 210). For instance, this measurement can be performed by using an A/D (analog-digital) converter to directly detect a voltage of a power supply terminal or comparing a predetermined reference voltage to the voltage of the power supply terminal with a voltage comparator.

Next, the microcomputer 21 determines whether or not there has been predetermined power supply voltage variation (step 211). It is determined whether or not there has been power supply voltage variation exceeding a predetermined range (±0.3 V or more, for instance) in reference to the power supply voltage at the time of setting the data N in the register 188 (in the case where, immediately after starting the operation, the data N has never been updated, it is determined in reference to the power supply voltage at the time of setting the data N before shipment). In the case where there has been little power supply voltage variation or power supply voltage variation with little variance, a negative judgment is made in the determination in the step 211 and this determination operation is repeated.

In the case where there has been power supply voltage variation exceeding the predetermined range, an affirmative judgment is made in the determination in the step 211, and then the microcomputer 21 varies the contents of the data N stored in the register 188 to a value corresponding to the power supply voltage after the variation (step 212). It is possible to measure in advance or acquire by calculation based on simulation the extent to which the data N stored in the register 188 should be varied according to the extent of the power supply voltage variation. Once the value of the data N stored in the register 188 is varied, it returns to the step 210 so as to repeat the process from the power supply voltage measurement onward.

According to the above-mentioned embodiment, the characteristics of the quadrature detector were adjusted. It is also possible, however, to apply the present invention to the detector of another method if the characteristic values are variable by adjusting the capacitance value of the variable capacitance circuit 182.

According to the above-mentioned embodiment, the receiving state of the receiver was measured by using the level meter 202. It is also possible, however, to use a distortion meter. In the case of using the distortion meter, the receiver is in the best receiving state when the distortion meter is at the lowest output level. Therefore, the subjects of value comparison should be reversed in the determination in the step 106 of FIG. 6 so as to determine whether or not the output (Vo′) of the distortion meter fetched later is smaller than the output (Vo) fetched earlier.

### INDUSTRIAL APPLICABILITY

According to the present invention, as described above, it is possible, even in the case where there are variations on manufacturing as to the element constants of the inductor and capacitor of the resonance circuit comprising the detector, to vary the capacitance value of the variable capacitance circuit formed on the semiconductor substrate and thereby adjust the characteristic values of the detector. Therefore, it is unnecessary, for the sake of obtaining good characteristics as the detector or the receiver, to select less variable parts or use expensive parts so as to alleviate the effort and cost.

1. A receiver comprising a detector of which characteristic values are varied by adjusting a capacitance value, characterized in that:
the detector comprises a variable capacitance circuit formed on a semiconductor substrate and a resonance circuit composed of an inductor and a first capacitor formed outside the semiconductor substrate; and
the characteristic values of the detector are adjustable by varying the capacitance value of the variable capacitance circuit.

2. The receiver according to claim 1, characterized in that the variable capacitance circuit comprises a plurality of second capacitors and switches for having each of the second capacitors combined and connected in parallel.

3. The receiver according to claim 2, characterized in that each of the plurality of second capacitors has a different capacitance from one another.

4. The receiver according to claim 2, characterized in that each of the plurality of second capacitors is set at twice the capacitance mutually.

5. The receiver according to claim 2, characterized in that the variable capacitance circuit further comprises a storage unit for storing data of the number of bits at least more than the number of switches and has a connection state of the switches set according to the values of the bits of the data stored in the storage unit.

6. The receiver according to claim 5, characterized by further comprising:
a nonvolatile memory holding the data corresponding to characteristic values of the detector for optimizing a receiving state measured in advance; and
a control unit for reading the data held in the memory and storing it in the storage unit before starting a receiving operation.

7. The receiver according to claim 6, characterized in that the control unit detects temperature of the detector and varies the contents of the data stored in the storage unit according to a variance of the temperature before starting the receiving operation.

8. The receiver according to claim 6, characterized in that the control unit detects a power supply voltage and varies the contents of the data stored in the storage unit according to the variance of the power supply voltage before starting the receiving operation.

9. The receiver according to claim 1, characterized in that the detector is a quadrature detector having π/2 phase shifter comprised of the resonance circuit and variable capacitance circuit; and
the capacitance value of the variable capacitance circuit is variable and a phase shift amount of the π/2 phase shifter against an input signal is thereby accurately adjustable to π/2.

10. The receiver according to claim 1, characterized in that the semiconductor substrate has other component circuits formed thereon integrally with the variable capacitance circuit.

11. The receiver according to claim 1, characterized in that the circuits on the semiconductor substrate are formed by using a CMOS process or a MOS process.

12. An adjustment system for adjusting the receiver according to claim 1 to an optimal receiving state, characterized by comprising:
a signal generator for inputting a test signal to the receiver;
a measuring instrument for measuring the receiving state of the receiver; and
an adjusting apparatus for determining the receiving state of the receiver based on a measurement result of the measuring instrument and switching a connection state of the plurality of second capacitors included in the variable capacitance circuit so as to optimize the receiving state.

13. An adjustment system for adjusting the receiver according to claim 6 to an optimal receiving state, characterized by comprising:
a signal generator for inputting a test signal to the receiver;
a measuring instrument for measuring the receiving state of the receiver; and
a controlling apparatus for determining the receiving state of the receiver based on the measurement result of the measuring instrument and determining the data to be stored in the storage unit and writing the data to the memory so as to optimize the receiving state.

14. An adjustment method for adjusting the receiver according to claim 1 to an optimal receiving state, characterized by comprising steps of:
inputting a test signal to the receiver;
measuring the receiving state of the receiver; and
determining the receiving state of the receiver based on the measurement result of the receiving state of the receiver and switching a connection state of the plurality of second capacitors included in the variable capacitance circuit so as to optimize the receiving state.

15. An adjustment method for adjusting the receiver according to claim 6 to an optimal receiving state, characterized by comprising the steps of:
inputting a test signal to the receiver;
measuring the receiving state of the receiver; and
determining the receiving state of the receiver based on the measurement result of the receiving state of the receiver, determining the data to be stored in the storage unit and writing the data to the memory so as to optimize the receiving state.
